(19) United States
(12) Patent Application Publication
(10) Pub. No.: US 2017/0205700 A1
(43) Pub. Date: Jul. 20, 2017

(54) SCREEN HAVING TWO OR MORE SCREEN REGIONS WITH DIFFERING SCREEN REFLECTANCE VALUES

(71) Applicant: CJ CGV CO., LTD., Seoul (KR)

(72) Inventors: Bon Il KOO, Seoul (KR); Byoung Jun SONG, Incheon (KR); Hae Jeong KOH, Seoul (KR); Min Jung KIM, Seoul (KR); Young Mi KIM, Seoul (KR); Ok Sun KIM, Seoul (KR); No Chan PARK, Incheon (KR); In Jae SEONG, Seoul (KR); Young Wook CHOI, Seoul (KR)

(73) Assignee: CJ CGV CO., LTD., Seoul (KR)

(21) Appl. No.: 15/326,465

(22) PCT Filed: Jul. 15, 2015
(86) PCT No.: PCT/KR2015/007353

§ 371 Date: Jan. 13, 2017

(30) Foreign Application Priority Data
Jul. 15, 2014 (KR) 10-2014-0089365
Jul. 15, 2015 (KR) 10-2015-0100290

(51) Int. Cl. G03B 21/606; G01J 1/44; B05D 7/00; G03B 21/60; B05D 5/06

(52) U.S. Cl. CPC G03B 21/606; G03B 21/60; B05D 5/063; B05D 7/54; G01J 1/44

(57) ABSTRACT

The present invention relates to a screen, and more specifically to a screen, to which a content images are projected, comprising screen regions each having a mutually different reflectance. According to the present invention, with respect to implementing a screen having a non-flat surface, as the content images can be projected onto all screen regions while maintaining uniform brightness, an audience can be provided with a content viewing environment by means of screens having a variety of shapes, while satisfactorily maintaining the quality of the of the projected a content images.

### TECHNICAL FIELD

The present invention relates to a screen and, more particularly, to a screen including screen regions having different reflectance in the screen on which a content image is projected.

According to the present invention, in implementing a screen other than a plane, a content image can be projected with uniform brightness in all of screen regions. Accordingly, there are advantages in that a content screening environment can be provided to audiences through screens of various shapes and quality of a projected content image can be excellently maintained.

### BACKGROUND ART

In line with the recent diversification of movie content, a theater that is the space where the movie content can be watched is also greatly advanced. More specifically, many theaters consider various means in order to provide audiences with a higher three-dimensional (3-D) effect and a higher sense of immersion away from the frame of a screening environment in which a conventional 2-D image is projected.

Recently, active research is carried out on a 3-D imaging technology in order to provide an image having a 3-D effect. The 3-D imaging technology enables different images to enter the left and right eyes of an audience and enables the audience to have a three-dimensional effect in a process of the different images being recognized by the brain. In the 3-D imaging technology, two cameras on which different polarization filters have been mounted are used upon photographing and glasses on which polarization filters have been mounted are used when content is played back, so different images enter a left eye and a right eye.

However, such a 3-D technology can provide an audience with an image having a three-dimensional effect, but has a problem in that a degree of immersion into an image itself is low because an audience merely watches an image played back on a plane screen or a plane picture. Furthermore, there is a problem in that an audience must wear special glasses in order to watch a single piece of 3-D content in terms of audience convenience.

Meanwhile, in order to improve such an inconvenient screening environment, there has recently been made an attempt to provide an image through a screen of a shape other than a plane in order to provide audiences with a sense of immersion. That is, there is introduced a theater in which a user can better feel a sense of immersion and a stereoscopic effect by providing an image through a screen having curvature in a specific direction other than a conventional screen of a planar and rectangular shape.

If a screen other than a plane is used as described above, however, a brightness difference in the image between different areas, such as that a specific area of the screen looks dark or a specific area of the screen looks bright, is generated. If a brightness difference is generated as described above, there are problems in that an audience feels uneasy when watching content and an intended sense of immersion and stereoscopic effect cannot be properly delivered to the audience.

The present invention has been made to solve such problems and also to satisfy the aforementioned technological needs and also has been invented to provide additional technological elements that may not be easily invented by those skilled in the art to which the present invention pertains.

### DISCLOSURE

### Technical Problem

An object of the present invention is to maintain uniform brightness in all of screen regions although a content image is projected by implementing a screen including two or more screen regions having different screen reflectance values or gains in the screen other than a plane.

More specifically, an object of the present invention is to maintain uniform brightness in all of screen regions when a content image is projected in implementing a screen in which a long axis or a short axis has curvature of a specific size.

More specifically, in this case, an object of the present invention is to implement a screen capable of generating the aforementioned effects by setting two or more screen regions within a single screen and coating paints having a different screen reflectance value (gain) on each of the screen regions.

Furthermore, an object of the present invention is to play back a content image without distortion by solving a problem in that brightness is different in each region of a screen and thus to enable audiences to feel a higher sense of immersion and stereoscopic effect. More specifically, an object of the present invention is to provide audiences with a stereoscopic effect generated because a projection distance is different for each screen region if a content image is projected on a screen having curvature in the long axis and the short axis and thus to enable audiences to feel a maximized sense of immersion when watching a 3-D content image so that the audiences can feel a stereoscopic effect when watching a 2-D content image as if the audiences watch a 3-D content image.

Furthermore, an object of the present invention is to uniformly maintain brightness for each screen region when a content image is played back in the state in which a screen has been inclined toward audiences and thus to provide audiences with a higher sense of immersion by implementing an ideal screening environment although the screen is further inclined toward the audiences, that is, although the distance between the audiences and the screen is further narrowed.

Furthermore, an object of the present invention is to concentrate even a sound reflected by a screen on audiences by implementing the screen of ovalness not having distortion.

### Technical Solution

A screen according to the present invention for solving the problems includes two or more screen regions having different screen reflectance values or gains.

Furthermore, the screen may have specific curvature in a long-axis direction or short-axis direction or may have specific curvature in the long-axis direction and the short-axis direction.

Furthermore, the two or more screen regions of the screen may be coated with different paints, respectively.

Furthermore, a content image is projected on the screen, and the paints having different screen reflectance values or gains are coated on the respective screen regions so that the screen regions on which the content image is projected have identical brightness.

Furthermore, in this case, the paints respectively coated on the two or more screen regions include two or more identical compositions, and composition ratios of the two or more identical compositions are different. Furthermore, in this case, the paints respectively coated on the two or more screen regions have different composition ratios of the compositions which influence the screen reflectance values or gains.

Meanwhile, the paints respectively coated on the two or more screen regions may include a combination of different compositions.

Meanwhile, a theater according to another aspect of the present invention includes a projection apparatus projecting a content image on a screen and the screen reflecting the content image projected by the projection apparatus, wherein the screen includes two or more screen regions having different screen reflectance values or gains.

Furthermore, in the theater, the screen is a shape other than a plane.

Furthermore, in the theater, the long axis or short axis of the screen has curvature of a specific size.

Meanwhile, a method for fabricating a screen according to yet another embodiment of the present invention includes the steps of setting two or more screen regions on a screen and coating two or more paints having different screen reflectance values or gains on the two or more screen regions.

Furthermore, in the method for fabricating a screen, the paints are coated on the two or more screen regions set on the screen so that a screen reflectance value at the boundary of the two or more screen regions is gradually increased or decreased.

Furthermore, the method for fabricating a screen may further include the step of deforming the screen so that the screen has curvature in a long-axis direction or/and a short-axis direction.

Meanwhile, a method for fabricating a screen according to yet another embodiment of the present invention includes the steps of obtaining brightness values of two or more screen regions set on a single screen and coating different paints on the respective screen regions so that all of the screen regions have an identical brightness value if the screen regions have different brightness values.

Furthermore, in the method for fabricating a screen, the step of obtaining the brightness values includes projecting a test image on the screen and obtaining the brightness values by detecting values of light reflected by the screen.

### Advantageous Effects

According to the present invention, there is an advantage in that a sense of immersion or a stereoscopic effect can be provided to audiences because the audiences can watch content with uniform brightness when a content image is projected on a screen other than a plane.

More specifically, the present invention has an advantage in that it can provide a better screening environment because it can solve a problem in that brightness in some screen region is too low or too high in implementing a screen having curvature in the long axis or short axis in order to provide a sense of immersion and a stereoscopic effect.

Furthermore, the present invention has advantages in that a content image can be played back without distortion by solving a problem in that brightness is different in each region of a screen and thus audiences can feel a higher sense of immersion and stereoscopic effect. More specifically, the present Invention has advantages in that it can provide audiences with a stereoscopic effect generated because a projection distance is different for each screen region if a content image is projected on a screen having curvature in the long axis and the short axis and thus audiences can feel a maximized sense of immersion when watching a 3-D content image so that the audiences can feel a stereoscopic effect when watching a 2-D content image as if the audiences watch a 3-D content image.

Furthermore, the present invention can maintain ovalness of a screen in the state in which the screen has been inclined toward audiences and can solve a problem in that brightness is different in each screen region according to ovalness. Accordingly, in accordance with the present invention, there is an advantage in that a high sense of immersion can be provided to audiences because a content image can be played back in the screen without a brightness difference although the distance between the audiences and the screen is further narrowed.

Furthermore, the present invention has an advantage in that it can concentrate even a sound reflected by a screen on audiences by implementing the screen of ovalness not having distortion.

### DESCRIPTION OF DRAWINGS

FIG. 1 schematically shows an overall configuration of a theater that is the premise of the present invention.

FIG. 2 is a diagram shown to illustrate each name of a screen according to the present invention.

FIGS. 3A and 3B show the state in which screen regions within a screen have been implemented to have different screen reflectance values or gains in accordance with the present invention.

FIGS. 4A and 4B show the state in which screen regions have been implemented to have different screen reflectance values in a screen other than a plane and the state in which brightness has been uniformly maintained when a content image is projected on the corresponding screen.

FIG. 5 shows the projection area and non-projection area of a screen according to the present invention without distinction of the area.

FIGS. 6 and 7 show a method for fabricating a screen according to order in accordance with an embodiment of the present invention.

### MODE FOR INVENTION

The details of the objects and technological configurations of the present invention and acting effects thereof will be more clearly understood from the following detailed description based on the accompanying drawings. Hereinafter, embodiments of the present invention are described in detail with reference to the accompanying drawings.

Embodiments disclosed in this specification should not be interpreted as limiting or used to limit the range of right of the present invention. It is evident to those skilled in the art that a description including the embodiments of this specification has various applications. Accordingly, unless otherwise defined by the claims, some embodiments described are illustrative for better understanding, and the range of right of the present invention is not intended to be restricted by the embodiments.

Function blocks illustrated in the drawings and described hereunder are only examples of possible implementations. In other implementations, different functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when it is said that one element is connected (or coupled) to the other element, it should be understood that one element may be directly connected or coupled to the other element, but a third element may exist between the two elements.

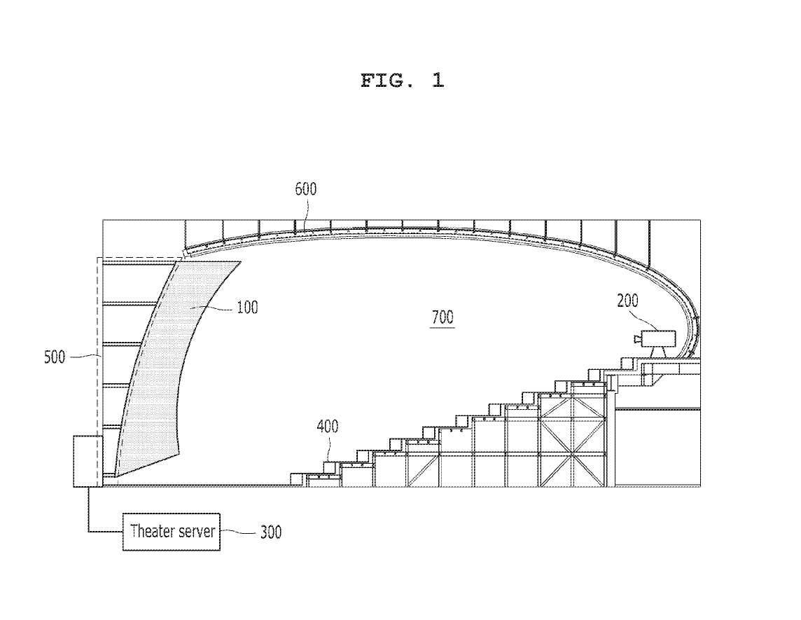

Prior to a description of the screen 100 according to the present invention, the entire theater, that is, the background of the present invention, is schematically described below with reference to FIG. 1.

Referring to FIG. 1, the theater includes a screen 100 according to the present invention and a projector 200 for projecting a content image on the screen 100 as basic elements. Meanwhile, in addition to the basic elements, the theater may further include a theater server 300 providing a content image, seats 400 on which audiences can sit, a frame for supporting the screen 100, a support 500 for supporting the frame, a ceiling 600 and the surface of a wall 700.

The screen 100 is a curtain which may be held in the frame, and generally refers to a thing that functions to reflect an image, projected by the projector 200, toward a surface. The materials of the screen 100 capable of reflecting a projected image as described above may include textiles or various kinds in which textiles have been subjected to coating treatment, such as mat white, glass beads, ultra beads, a film, fiber glass and diamond.

Meanwhile, a shape of the screen 100 according to the present invention is not essentially limited to a plane. For example, the screen 100 according to the present invention may have curvature of a specific size in the direction of a long axis 110 or short axis 130 or may be implemented in the form of so-called ovalness having curvature of a specific size both in the directions of the long axis 110 and short axis 130.

As may be seen from FIG. 1, the screen 100 according to the present invention may be implemented as ovalness of a form concave toward the seats 400. If curvature is generated in the long axis 110 or short axis 130 of the screen 100 as described above, there is an advantage in that a higher sense of immersion and stereoscopic effect can be provided to audiences.

Next, the theater includes the projector 200. The projector 200 refers to an apparatus for directly projecting an externally received content image on the screen 100. As may be seen from FIG. 1, one or more projectors 200 may be installed in such a way as to face the screen 100. Meanwhile, in FIG. 1, only a single projector 200 for projecting a content image on the screen 100 has been illustrated, but the theater may also include the surface of a wall 700 and the ceiling 600 as projection surfaces on which an image can be projected in addition to the screen 100. It to be understood that the projectors 200 for projection may also be additionally installed on the projection surfaces.

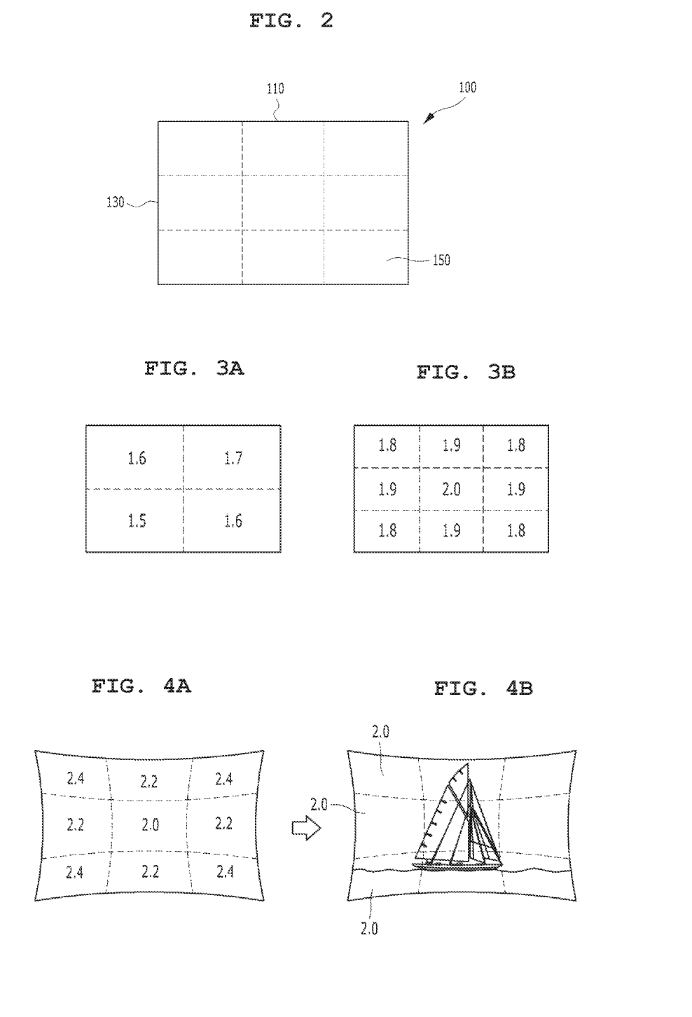

Each name of the screen 100 according to the present invention is defined below with reference to FIG. 2.

First, a side that belongs to the sides of the screen 100 according to the present invention and that has a relatively longer length is defined as the long axis 110, and a side that belongs to the sides of the screen 100 according to the present invention and that has a relatively shorter length is defined as the short axis 130. Preferably, the horizontal side of the screen 100 is defined as the long axis 110, and the vertical side thereof is defined as the short axis 130 as shown in FIG. 2.

Meanwhile, the screen 100 according to the present invention may be implemented so that the long axis 110 or the short axis 130 has curvature of a specific size. For example, both the upper and lower long axes 110 of the screen 100 may have the same first curvature value, thereby implementing the screen 100 curved in the horizontal direction. Alternatively, the left and right short axes 130 of the screen 100 may have the same second curvature value, thereby implementing the screen 100 curved in the vertical direction. Furthermore, the upper and lower long axes 110 may have a first curvature value and the left and right short axes 130 may have a second curvature value so that the screen 100 is implemented to have ovalness.

Meanwhile, the upper and lower long axes 110 of the screen 100 may be implemented to have different curvature values. For example, the first long axis 110, that is, the upper long axis 110, may be implemented to have a first curvature value, and the second long axis 110, that is, the lower long axis 110, may be implemented to have a second curvature value so that the degrees to which the upper and lower ends of the screen 100 are bent are different. Likewise, the left short axis 130 of the screen 100 may be defined as a first short axis 130 and the right short axis 130 may be defined as a second short axis 130 so that the left and right short axes 130 have different curvature values.

The screen 100 according to the present invention includes screen regions 150 in addition to the long axis 110 and the short axis 130. The screen regions 150 refer to respective set regions if a single screen 100 is set for each specific region. From FIG. 2, it may be seen that the screen 100 includes a total of nine screen regions 150.

Such screen regions 150 are the results of regions virtually set with respect to the screen 100. The screen regions 150 do not need to be essentially divided vertically and horizontally as in FIG. 2. As will be described later, the screen regions 150 may be divided based on the degree to which a content image is reflected by the screen 100 when the content image is projected.

The screen 100 according to the present invention is described in more detail below with reference to FIGS. 3A and 3B.

FIGS. 3A and 3B show the state in which the screen 100 is set a plurality of screen regions 150 and the screen regions 150 have different screen reflectance values.

FIG. 3A shows the state in which a single screen 100 has been set as four screen regions 150. Referring to FIG. 3A, the screen 100 includes screen regions 150 having different screen reflectance values, such as a first screen region 150 having a screen reflectance value of 1.6, a second screen region 150 having a screen reflectance value of 1.7, a third screen region 150 having a screen reflectance value of 1.5 and a fourth screen region 150 having a screen reflectance value of 1.6.

It means that as the screen reflectance value becomes higher, an image looks brighter because reflectance of light is high. Accordingly, referring to FIG. 3A, this means that when a single content image is projected on a planar screen 100, the highest brightness is measured in the second screen region 150 and the lowest brightness is measured in the third screen region 150.

Meanwhile, FIG. 3B shows the state in which a single screen 100 has been set as 9 screen regions 150. From FIG. 3B, it may be seen that the first, third, seventh and ninth screen regions 150 of the screen 100 have been implemented to have a screen reflectance value of 1.8, the second, fourth, sixth and eighth screen regions 150 thereof have been implemented to have a screen reflectance value of 1.9, and the fifth screen region 150 thereof has been implemented to have a screen reflectance value of 2.0. Accordingly, when a content image is projected on the screen 100 of FIG. 3B, audiences who watch the content image may recognize that the central part of the screen 100 is the brightest and that surrounding areas become darker as they become distant from the central part.

Meanwhile, the screen reflectance value of the screen region 150 may be adjusted in accordance with a composition or composition ratio of paints coated on the corresponding screen region 150.

That is, in general, one kind of paints is coated on a single screen 100, and thus all the regions of the corresponding screen 100 have a uniform screen reflectance value. In the present invention, in order to assign different screen reflectance values to the respective screen regions 150, different paints are coated on the screen regions 150 or paints having the same composition are used, but paints having different ratios of the composition are coated on the screen regions 150.

For example, the screen according to the present invention may be implemented as a silver screen. In the silver screen, the paints of the silver screen are coated on the entire screen, but may be coated so that a screen reflectance value is different in each of the screen regions of the silver screen by adjusting a mixing ratio of specific compositions in order to assign a different screen reflectance value to each screen region or using compositions having different particle sizes.

Meanwhile, various compositions of the paints may be mixed at different ratios so that a different screen reflectance value is derived according to the ratio. Alternatively, the paints are a combination of different compositions, and different screen reflectance values may be derived according to a combination of the different compositions.

FIGS. 4A and 4B show a preferred embodiment of the screen 100 according to the present invention.

As described above in brief, the screen 100 according to the present invention may be a screen 100 other than a plane. More precisely, the screen 100 may be implemented to have the long axis 110 and short axis 130 of curvature of a specific size so that the screen 100 look likes a concave shape by audiences.

Meanwhile, the projector 200 is disposed in the theater in such a way as to face the screen 100. In this case, if the screen 100 has ovalness as shown in FIG. 4A, a content image tends to slightly look dark in some region of the screen 100 because light projected by the projector 200 does not uniformly reach all the screen regions of the screen 100. If brightness of a content image is different on the screen 100 for each screen region 150 as described above, there is a problem in that audiences cannot have a proper sense of immersion and stereoscopic effect.

In the present invention, in order to solve such a problem, the screen 100 is set according to a plurality of screen regions 150 and implemented so that the screen regions 150 have different screen reflectance values. In this case, in order for the screen regions 150 to have different screen reflectance values, paints having a combination of different compositions or paints having a combination of the same compositions or having a mixture of different ratios are coated on the screen regions 150, as described above with reference to FIGS. 3A and 3B.

FIG. 4B shows the state in which uniform brightness appears in all of the screen regions 150 when a content image is projected on the screen 100 implemented so that the screen regions 150 have different screen reflectance values as in FIG. 4A.

That is, referring to FIG. 4B, the amount of light of a content image projected by the projector 200 may be different in the screen regions 150 because the same amount of light does not reach all of the screen regions 150. In the present invention, the screen regions 150 of the screen 100 are fabricated to have different screen reflectance values by taking such a difference into consideration. Accordingly, audiences can watch an image having uniform brightness in all of the screen regions 150 on the screen 100 of ovalness.

Meanwhile, in this case, it is necessary to determine a criterion by which a content image is to be played back in all of the screen regions 150 at which brightness value. That is, paints are coated on the screen regions 150, but it is necessary to determine a criterion by which a content image is uniformly seen by audiences at which brightness value.

This may be selected and/or designed and changed by a producer. For example, a producer may coat paints on the screen regions 150 so that brightness in a screen region 150 that belongs to the screen regions 150 and that is the lowest of the screen reflectance values of the screen regions 150 in content images reflected by the screen regions 150 is uniformly displayed on the entire screen. More specifically, referring to FIG. 4A, a portion that belongs to the screen regions 150 and that has the lowest screen reflectance value is a central portion having a value of 2.0. In this case, paints may be coated so that brightness of a reflected content image is implemented in other screen regions 150 when the content image is reflected by the central portion and seen by audiences. Meanwhile, if brightness is set based on a screen region 150 having the lowest screen reflectance value as in the present embodiment, there is an advantage in that the uniformity of the entire screen can be maintained relatively easily as a screen reflectance value decreases.

That is, the screen according to the present invention is implemented to have a uniform brightness value in all of the screen regions 150 when a content image is finally played back, but any one brightness value may be determined according to various criteria.

Meanwhile, the screen regions 150 described in the present invention are concepts divided to easily know that different screen reflectance values are derived on the screen in terms of optics. It is to be understood that the surrounding boundaries of the screen regions 150 may be clearly distinguished or the screen regions 150 may be coated in a gradation manner so that screen reflectance values at the boundaries are gradually increased or decreased.

Meanwhile, FIG. 5 shows the screen 100 according to another embodiment of the present invention.

Referring to FIG. 5, the screen 100 according to the present invention may further include a non-projection area (area B) necessary to hold the screen in a frame in addition to the projection area (area A) on which a content image is projected.

The projection area refers to an area which a content image projected by the projector may be directly reflected. Two or more screen regions may be set in the projection area as described above, and paints capable of implementing different screen reflectance values may be coated on the respective screen regions.

The non-projection area refers to an area with which a content image projected by the projector does not directly come into contact. The non-projection area includes an additional area necessary to hold the screen in the frame. For example, in order for a single screen to be held in the frame, the screen and the frame are bound and connected by a strap. In this case, a plurality of the straps may be provided in the non-projection area.

Meanwhile, the projection area and non-projection area of the screen 100 may be partitioned by guide lines or guide points. As shown in FIG. 5, the guide lines or the guide points may be inserted so that the projection area and the non-projection area are easily distinguished from each other. The guide line or the guide point may be used to adjust the location where the screen is installed when the screen is held in the frame. That is, when the screen is to be held in the frame, the guide lines or the guide points and the long-axis members and short-axis members of the frame are matched in parallel, thereby being capable of easily holding the screen in the frame.

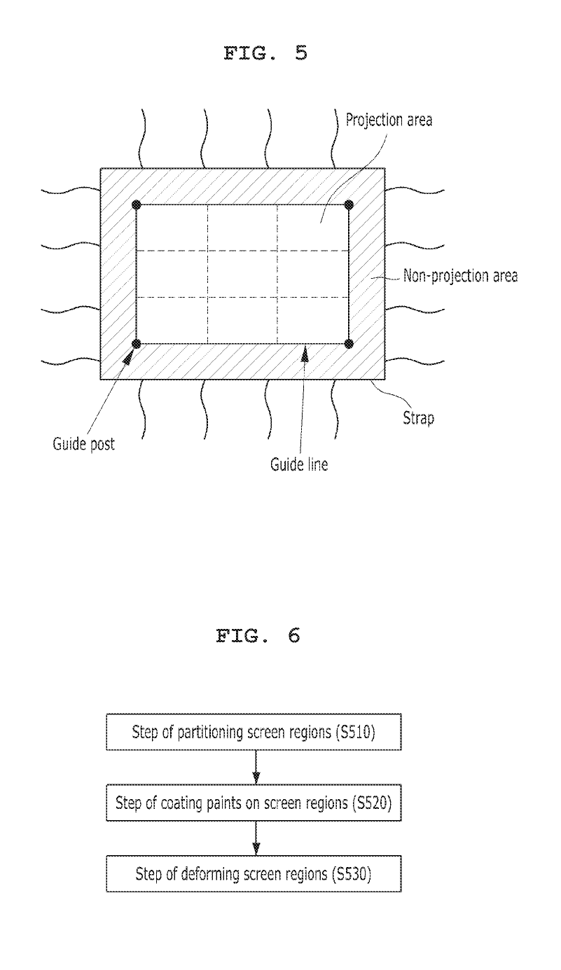

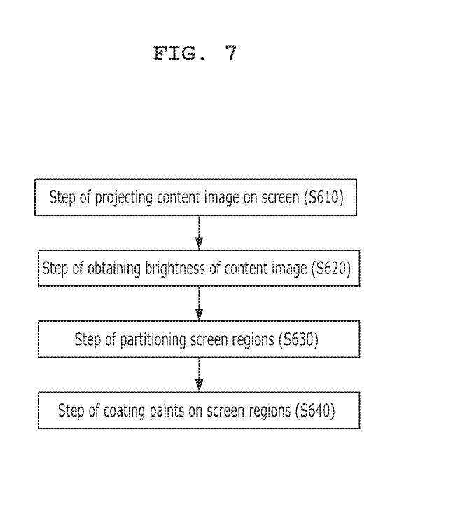

A method for fabricating the screen 100 according to the present invention is described below with reference to FIGS. 6 and 7.

FIG. 6 shows a flowchart of the method for fabricating the device 100 according to a first embodiment of the present invention.

In accordance with the first embodiment, the method for fabricating the device 100 first starts from the step of setting two or more screen regions 150 on a single screen 100. That is, in a conventional technology, an attempt to separately set the screen regions 150 on the screen 100 has not been made. In contrast, an object of the present invention is to assign various screen reflectance values to respective regions on the screen 100. The first step starts from the setting a plurality of the screen regions 150 (S510).

Meanwhile, the plurality of screen regions 150 may be randomly set. In this case, it is preferred that the screen regions 150 are divided by taking into consideration a projection environment within a theater. For example, the screen regions 150 may be divided according to a projection environment within the theater, such as brightness for each screen region 150 according to the location where the screen 100 is installed within the theater, brightness for each screen region 150 according to performance of the projector 200, and brightness for each screen region 150 according to a shadow loomed by a device near the screen 100. Alternatively, if the shape of the long axis 110 or the short axis 130 is to be deformed into the screen 100 of ovalness having curvature as shown in. FIGS. 4A and 4B, the screen regions 150 may be set by taking into consideration brightness when a content image projected by the projector 200 is reflected by the screen 100.

Meanwhile, after the plurality of screen regions 150 is divided on the single screen 100 as described above, two or more paints having different screen reflectance values are coated on the respective screen regions 150 (S520).

In this case, it is to be understood that the type of paints coated on the respective screen regions 150 is the same as or less than the number of screen regions 150. That is, the same paints may be coated on some of the plurality of screen regions 150 so that they have the same screen reflectance value. The type of paints having different screen reflectance values needs to be the same or less than the number of screen regions 150.

Meanwhile, although described above, the paints are materials that determine a screen reflectance value. The paints may have the same composition, but have different composition ratios or may have different compositions.

The method for fabricating the device 100 according to the first embodiment of the present invention may be completed after step S520 is performed. In this case, with consideration taken that an implementation shape of the screen 100 according to the present invention is a shape not a plane, the method may further include a step (S530) of deforming the shape of the screen 100 so that curvature is generated in the direction of the long axis 110 or short axis 130 of the screen 100 after step S520. Meanwhile, in this case, deforming the shape of the screen 100 means that curvature is generated in the direction of the long axis 110 or short axis 130 of the screen 100 itself. In this case, it is to be understood that the curvature is generated when the screen 100 is held in a frame having such a shape.

Meanwhile, the screen 100 completed after the paints are coated on the respective screen regions 150 and the shape of the long axis 110 or short axis 130 is deformed as described above is fixed to a frame for holding the screen 100. Furthermore, the frame to which the screen 100 has been fixed is coupled to the support 500 within a theater and located at the front within the theater.

FIG. 7 shows a method for fabricating the device 100 according to a second embodiment of the present invention according to order.

The method for fabricating the screen 100 according to the second embodiment first starts from a step (S610) of projecting a content image on the screen 100. Step S610 is for taking into consideration a projection environment of the screen 100. Step S610 is for obtaining brightness of a content image (S620) in each of the screen regions of the screen 100 by projecting a content image, that is, a test image, on an uncompleted screen 100 having a generally uniform screen reflectance value in an environment similar to a projection environment in the future. Meanwhile, in this case, the image projected on the screen 100 may preferably include only a screen including only a single color. This is for more precisely measuring brightness values in the respective screen regions 150.

Meanwhile, a content image may be projected on the screen 100 by controlling different devices at steps S610 and S620, for example, a prepared projector 200 at step S610. Step S620 may be performed using an independent detection device for measuring the brightness value of an image. Meanwhile, steps S610 and S620 may be performed using a single device having both the function of projecting a content image and the function of measuring the brightness value of an image reflected by the screen 100. Meanwhile, in accordance with the present invention, the brightness value measured by such a process may be matched with a shape of the corresponding screen 100, that is, may be databased and stored as in Table 1. For example, parameters, such as curvature of a long-axis member and curvature of a short-axis member which may be used to identify the shape of a specific screen 100, and brightness values (in this case, the unit of a measured brightness value is fL) corresponding to respective screen regions measured as a result of the projection of a test image on the screen may be matched and stored. This is for preventing the redundancy of a measuring task by applying a similar method for fabricating a screen to a screen having the same shape in the future.

Meanwhile, in Table 1 below, it is to be understood that the first long-axis member and the second long-axis member are indications for distinguishing the long-axis members of the upper end or lower end of each screen.

TABLE 1

| Brightness distribution | First long-axis member:second long- | | | |
|---|---|---|---|---|
| (brightness fL) | axis member curvature | | | |
| Short-axis member | 8,000:8,000 | | | |
| curvature 8,000 | 10.1 | 11.4 | 12.3 | 11.5 |
| | 10.7 | 14.6 | 12.7 | 9 |
| | 9.3 | 12.7 | 13 | 12 |
| | 11 | 11.4 | 11.5 | 11 |
| | 8.6 score | | | |
| | 10,000:10,000 | | | |
| | 10.1 | 11.5 | 12.4 | 11.9 |
| | 10.4 | 12.6 | 12.7 | 11.2 |
| | 11.4 | 12.7 | 12.8 | 12 |
| | 11.5 | 11.2 | 12.1 | 11.1 |
| | 9.2 score | | | |
| | 15,000:15,000 | | | |
| | 10.2 | 11.4 | 12.3 | 11.2 |
| | 11.3 | 12.5 | 11.2 | 10.3 |
| | 11.6 | 12.7 | 12.4 | 11.4 |
| | 10.4 | 9.9 | 11.5 | 10.4 |
| | 9.1 score | | | |
| Short-axis member | 10,000:8,000 | | | |
| curvature 10,000 | 6.6 | 11.4 | 12.3 | 5.6 |
| | 8.5 | 13.5 | 11.2 | 7.6 |
| | 9.3 | 12.7 | 13 | 12 |
| | 7.7 | 9.9 | 11.5 | 8.8 |
| | 7.5 score | | | |
| | 8,000:10,000 | | | |
| | 3 | 6.7 | 8.8 | 3.4 |
| | 4.1 | 13.7 | 12.4 | 7.4 |
| | 2.6 | 8.6 | 7.8 | 4.1 |
| | 5.1 | 3 | 3.1 | 4 |
| | 6.6 score | | | |
| | 15,000:15,000 | | | |
| | 9.7 | 10.2 | 10 | 9.8 |
| | 10.4 | 11.2 | 12.1 | 11.2 |
| | 10.2 | 11.4 | 10.2 | 10.9 |
| | 8.9 | 9.7 | 9.8 | 10 |
| | 9.2 score | | | |
| Short-axis member | 8,000:8,000 | | | |
| curvature 15,000 | 1.6 | 3.5 | 4.3 | 1 |
| | 2.5 | 16 | 14 | 0.2 |
| | 1 | 8.3 | 6.8 | 2.1 |
| | 3.2 | 5 | 2.4 | 1.5 |
| | 5.4 score | | | |
| | 10,000:10,000 | | | |
| | 3.6 | 4.7 | 2.7 | 1.8 |
| | 2.7 | 14.2 | 11 | 2.8 |
| | 1.4 | 16.3 | 8.4 | 2.6 |
| | 2.4 | 5 | 6.4 | 1.4 |
| | 5.3 score | | | |
| | 15,000:15,000 | | | |
| | 8.6 | 11.4 | 12.3 | 7.9 |
| | 9.2 | 13.5 | 11.2 | 8.9 |
| | 9.3 | 12.7 | 13 | 10 |
| | 9.3 | 9.9 | 11.5 | 8.8 |

8.2 score

Meanwhile, after the brightness of the image reflected by the screen 100 is obtained, the screen 100 is set as two or more screen regions 150 (S630) based on the obtained brightness. Paints having different screen reflectance values are coated on the respective set screen regions 150 (S640).

Unlike in the first embodiment, the method for fabricating the device 100 according to the second embodiment is different in that brightness in each of the screen regions 150 can be precisely obtained by projecting a content image on the screen 100 on trial in a previously implemented projection environment.

Meanwhile, the method for fabricating the screen according to the present invention may further include a step of databasing and storing that paints having which screen reflectance value have been coated on each of the screen regions 150 according to the conditions of an implemented screen 100, such as the shape, material, etc. of the screen 100.

For example, if a proper screen reflectance value in each of the screen regions 150 or a brightness value when a content image is played back is obtained through simulations according to the first embodiment or second embodiment when a first screen is disposed in a theater of a specific area, a shape of the screen, a screen reflectance value for each screen region of the corresponding screen, a composition of paints coated on each screen region, a composition ratio of the paints, and a brightness value when a content image is played back may be matched up as a single set and stored.

For example, in the case of the screen of FIGS. 4A and 4B, i) the long-axis length and short-axis length of the screen, ii) curvature of the long-axis members or curvature of the short-axis members, iii) a proper screen reflectance value for each of the screen regions set on the screen, iv) a composition and composition ratio of paints coated to implement the screen reflectance value of each screen region, and v) a brightness value when a content image is projected on the screen coated with the paints may be databased and stored.

Although some embodiments and application examples of the present invention have been illustrated and described above, the present invention is not limited to the aforementioned specific embodiments and application examples and may be deformed in various ways by those skilled in the art to which the present invention pertains without departing from the gist of the present invention written in the claims. Such deformed embodiments should not be construed as being distinct from the technological spirit or prospect of the present invention.

1-17. (canceled)

18. A screen on which a content image is projected, comprising:
two or more screen regions having different screen reflectance values.

19. The screen of claim 18, wherein the screen has specific curvature in a long-axis direction.

20. The screen of claim 18, wherein the screen has specific curvature in a short-axis direction.

21. The screen of claim 18, wherein the screen has specific curvature in a long-axis direction and a short-axis direction.

22. The screen of claim 18, wherein the two or more screen regions are coated with different paints.

23. The screen of claim 22, wherein the paints having different screen reflectance values are coated on the respective screen regions so that the screen regions on which a content image is projected have identical brightness.

24. The screen of claim 23, wherein:
the paints respectively coated on the two or more screen regions comprise two or more identical compositions, and
composition ratios of the two or more identical compositions are different.

25. The screen of claim 24, wherein the paints respectively coated on the two or more screen regions have different composition ratios of the compositions which influence the screen reflectance values.

26. The screen of claim 23, wherein the paints respectively coated on the two or more screen regions comprise a combination of different compositions.

27. A method for fabricating a screen, comprising steps of:
setting two or more screen regions on a screen; and
coating two or more paints having different screen reflectance values on the two or more screen regions.

28. The method of claim 27, wherein the paints are coated on the two or more screen regions set on the screen so that a screen reflectance value at a boundary of the two or more screen regions is gradually increased or decreased.

29. The method of claim 27, further comprising a step of deforming the screen so that the screen has curvature in a long-axis direction or/and a short-axis direction.

30. A method for fabricating a screen, comprising steps of:
obtaining brightness values of two or more screen regions set on a single screen; and
coating different paints on the respective screen regions so that all of the screen regions have an identical brightness value if the screen regions have different brightness values.

31. The method of claim 30, wherein the step of obtaining the brightness values comprises:
projecting a test image on the screen, and
obtaining the brightness values by detecting values of light reflected by the screen.
